(19) United States
(12) Patent Application Publication
(10) Pub. No.: US 2012/0075211 A1
(43) Pub. Date: Mar. 29, 2012

(54) Touch detector, display unit with touch detection function, touched-position detecting method, and electronic device

(75) Inventor: Ryoichi Tsuzaki, Kanagawa (JP)

(73) Assignee: Sony Corporation, Tokyo (JP)

(21) Appl. No.: 13/137,341

(22) Filed: Aug. 8, 2011

(30) Foreign Application Priority Data
Sep. 27, 2010 (JP) 2010-215532

(51) Int. Cl. G06F 3/041

(52) U.S. Cl. 345/173

(57) ABSTRACT

A touch detector includes a touch detecting section generating detection intensity mapping information including detection intensity values according to an external proximity object, and a touched-position detecting section determining a touched position based on one or a plurality of touch regions determined by comparing each of the detection intensity values with a predetermined threshold. The touched-position detecting section selects an effective region from the one or each of the plurality of touch regions, establishes a computation region for the effective region, and determines a centroid as the touched position with use of the detection intensity values in the computation region.

### BACKGROUND

The present disclosure relates to a touch detector, a display unit with a touch detection function, a touched-position detecting method, and an electronic device, by which an external proximity object may be detected.

In recent years, attention has been given to such a display unit configured by mounting a contact sensing device, a so-called touch panel, on a display unit such as a liquid crystal display or the like, or integrating the touch panel and the display unit, thereby causing the display unit to display various button images and the like to enable information input, in place of ordinary mechanical buttons. The display unit having such a touch panel is not necessary to have an input device such as a keyboard, a mouse, or a keypad and therefore, there is a growing trend to use the display unit in a portable information terminal such as a portable telephone, in addition to a computer.

For example, Japanese Unexamined Patent Application Publication No. 2009-193329 discloses a display unit with a touch detection function in which a display unit and an optical touch detector are integrated. In this display unit with the touch detection function, for instance, a peak value of each detection intensity in an image pickup image (a detection intensity map) of the touch detector and its position are detected, a value of neighboring detection intensity is also detected, and touch detection is carried out based on a difference between the peak value and the value of the neighboring detection intensity. This makes it possible for this display unit with the touch detection function to detect a touch of a proximity object easily, even when the proximity object is, for example, a pointed object such as a pen.

### SUMMARY

In a touch detector, the accuracy of detecting a touched position is important in general. When each touch sensor element of the touch detector is provided for every display pixel, it is generally easy to achieve high position detection accuracy. However, when each touch sensor element is provided for every two or more display pixels instead of being provided for every display pixel due to, for example, manufacturing cost, some kind of technical limitations, or the like, the position detection accuracy may be reduced. In a touch detector having such low location accuracy, when, for example, a slant straight line is drawn with a touch, the line is recognized as a jaggy line, not as a straight line.

Japanese Unexamined Patent Application Publication No. 2009-193329 describes the fact that the position detection accuracy may be increased by determining a weighted centroid based on detection intensity values, in a position having a peak value and its neighboring region. However, when, for example, an external proximity object touches a touch detection surface over a large area, the position where the detection intensity becomes the peak value may not be determined precisely and thus, the position detection accuracy may be reduced.

Further, in recent years, as for touch detectors, a multi-touch system in which operation is performed, for example, by touching with two fingers at the same time has been receiving attention. However, Japanese Unexamined Patent Application Publication No. 2009-193329 does not describe the display unit with the touch detection function as being capable of detecting two or more touches at the same time.

In view of the foregoing, it is desirable to provide a touch detector, a display unit with a touch detection function, a touched-position detecting method, and an electronic device, in which, firstly, accuracy of detecting a touched position may be increased, and secondly, two or more touches are detected simultaneously.

According to an embodiment of the present disclosure, there is provided a touch detector including: a touch detecting section generating detection intensity mapping information including detection intensity values according to an external proximity object; and a touched-position detecting section determining a touched position based on one or a plurality of touch regions determined by comparing each of the detection intensity values with a predetermined threshold. The touched-position detecting section selects an effective region from the one or each of the plurality of touch regions, establishes a computation region for the effective region, and determines a centroid as the touched position with use of the detection intensity values in the computation region.

According to an embodiment of the present disclosure, there is provided a display unit with a touch detection function, the display unit including: a plurality of display elements; a touch detecting section generating detection intensity mapping information including detection intensity values according to an external proximity object; and a touched-position detecting section determining a touched position based on one or a plurality of touch regions determined by comparing each of the detection intensity values with a predetermined threshold. The touched-position detecting section selects an effective region from the one or each of the plurality of touch regions, establishes a computation region for the effective region, and determines a centroid as the touched position with use of the detection intensity values in the computation region.

According to an embodiment of the present disclosure, there is provided a touched-position detecting method including: determining one or a plurality of touch regions by comparing, based on detection intensity mapping information including detection intensity value according to an external proximity object, the detection intensity value with a predetermined threshold; selecting an effective region from the one or each of the plurality of touch regions; establishing a computation region for the effective region; and determining a centroid as the touched position with use of the detection intensity values in the computation region.

According to an embodiment of the present disclosure, there is provided an electronic device including the above-described display unit with the touch detection function, and corresponds to, for example, a television receiver, a digital camera, a laptop computer, a video camera, or a portable terminal device such as a portable telephone.

In the touch detector, the touched-position detecting method, and the electronic device according to the embodiments of the present disclosure, the touched position is determined based on the touch region determined by the detection intensity mapping information. At the time, the computation region is established for the effective regions that are effective among the touch regions, and the touched position is determined with use of the detection intensity values in the computation region.

In the touch detector according to the embodiment of the present disclosure, for example, it is possible to establish the computation region in the following two methods. In a first method, the computation region is established to include the center of the selected effective region. In this case, for example, the touch detecting section may include a plurality of touch detecting element arranged side by side in an arrangement density of the touch detecting elements in one direction differing from that in another direction, and the computation region may be established to be broader in a direction where the arrangement density of the touch detecting elements is low. In a second method, the computation region is established for a region which includes the effective region and is determined by comparing each of the detection intensity values in the detection intensity mapping information with another threshold lower than the predetermined threshold.

It is desirable that, for example, the touch detecting section detect a noise region resulting from a noise, from among the one or a plurality of touch regions and select a region other than the noise region as the effective region. Further, for example, the touch detecting section may generate the detection intensity mapping information based on a variation in capacitance due to the external proximity object.

According to the touch detector, the display unit with the touch detection function, the touched-position detecting method, and the electronic device in the embodiments of the present disclosure, the computation region is established for each of the effective regions and the touched position is determined with use of detection intensity values in the computation region. Therefore, it is possible to increase the accuracy of touched position detection and may detect a plurality of touches at the same time.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram illustrating a configurational example of an information input-output device according to an embodiment of the present disclosure.

FIG. 2 is a cross-sectional diagram illustrating a schematic sectional structure of a display unit with a touch detection function illustrated in FIG. 1.

FIG. 3 is a circuit diagram illustrating a pixel array of the display with the touch detection function illustrated in FIG. 1.

FIG. 4 is a perspective diagram illustrating a configurational example of a common electrode and a touch detection electrode of the display with the touch detection function illustrated in FIG. 1.

FIG. 5 is a flowchart illustrating an example of operation of an object-information detecting section according to a first embodiment.

FIG. 6A to 6C are schematic diagrams illustrating an example of the operation of the object-information detecting section according to the first embodiment:

FIG. 7 is a flowchart illustrating an example of operation of an object-information detecting section according to a second embodiment.

FIGS. 8A to 8C are schematic diagrams illustrating an example of the operation of the object-information detecting section according to the second embodiment.

FIG. 9 is a perspective diagram illustrating an appearance configuration of an application example 1 of a touch detector to which the embodiments is applied.

FIGS. 10A and 10B are perspective diagrams each illustrating an appearance configuration of an application example 2.

FIG. 11 is a perspective diagram illustrating an appearance configuration of an application example 3.

FIG. 12 is a perspective diagram illustrating an appearance configuration of an application example 4.

FIGS. 13A to 13G are front views, side views, a top view, and a bottom view each illustrating an appearance configuration of an application example 5.

FIG. 14 is a block diagram illustrating a configurational example of an information input-output device according to a modification.

FIG. 15 is a cross-sectional diagram illustrating a schematic sectional structure of a display unit with a touch detection function according to a modification.

### DETAILED DESCRIPTION OF EMBODIMENTS

Embodiments of the present disclosure will be described below in detail with reference to the drawings. The description will be provided in the following order.

### 1. First Embodiment

### 2. Second Embodiment

### 3. Application Examples

### 1. First Embodiment

### (Example of Configuration)

### [Example of Overall Configuration]

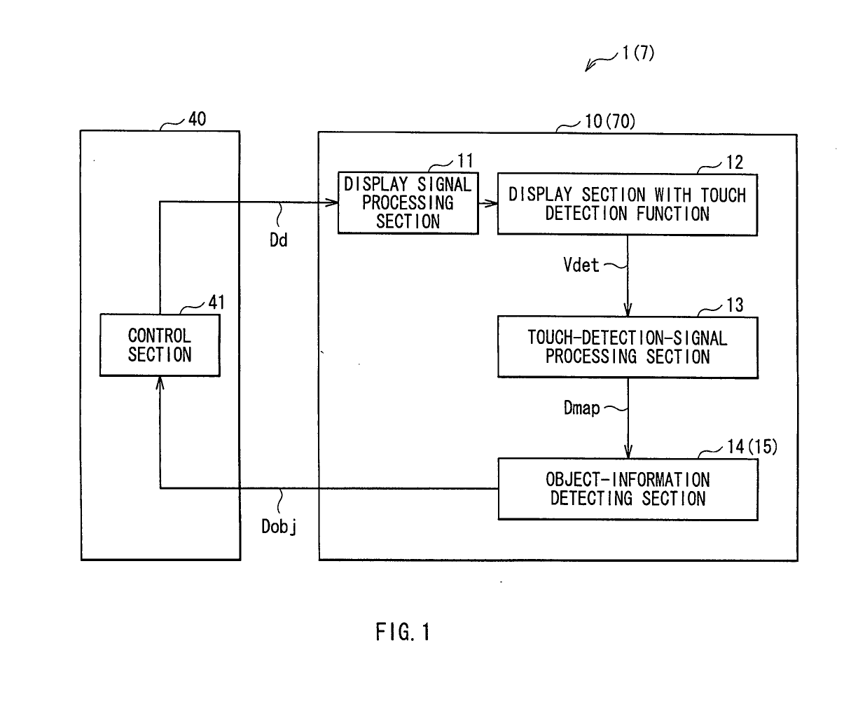

FIG. 1 illustrates a configurational example of an information input-output device according to the first embodiment of the present disclosure. It is to be noted that the touch detector, the display unit with the touch detection function, and the touched-position detecting method according to the embodiment are exemplified by the present embodiment and thus will be described collectively.

The information input-output device 1 includes a display panel 10 with a touch detection function, and an electronic-device main unit 40.

The display panel 10 with the touch detection function performs display based on display data Dd supplied from the electronic-device main unit 40, and detects an external proximity object, thereby supplying object information Dobj such as a touched position of the object to the electronic-device main unit 40. In this example, this display panel 10 with the touch detection function is of a so-called in-cell type in which a liquid crystal display and a capacitance touch detection device are integrated. The display panel 10 with the touch detection function includes a display-signal processing section 11, a display section 12 with a touch detection function, a touch-detection-signal processing section 13, and an object-information detecting section 14.

The display-signal processing section 11 is a circuit that generates various control signals based on the display data Dd, thereby driving the display section 12 with the touch detection function.

The display section 12 with the touch detection function is a display section having a function to detect an external proximity object. The display section 12 with the touch detection function performs display operation based on each of the various control signals supplied from the display-signal processing section 11, outputs a touch detection signal Vdet according to an external proximity object near or touching a touch detection surface, and supplies the touch detection signal Vdet to the touch-detection-signal processing section 13.

The touch-detection-signal processing section 13 has a function to generate a map (a detection intensity map Dmap) indicating detection intensity in each part of the touch detection surface, based on the touch detection signal Vdet supplied from the display section 12 with the touch detection function, and to supply the generated map to the object-information detecting section 14.

The object-information detecting section 14 has a function to determine the object information Dobj of the external proximity object, based on the detection intensity map Dmap supplied from the touch-detection-signal processing section 13, and to supply the determined object information Dobj to the electronic-device main unit 40. Here, the object information Dobj is, for example, the touched position of the external proximity object on the touch detection surface, or the range or size of the touch, or the like. At this time, as will be described later, at first, the object-information detecting section 14 roughly determines a touched position based on the detection intensity map Dmap, and then determines a touched position again with higher accuracy by narrowing a region.

The electronic-device main unit 40 has a control section 41. The control section 41 generates the display data Dd to be supplied to the display panel 10 with the touch detection function, receives the object information Dobj supplied from the display panel 10 with the touch detection function, and supplies the received object information Dobj to other circuit block in the electronic-device main unit 40.

[Display Section 12 with Touch Detection Function]

Next, a configurational example of the display section 12 with the touch detection function will be described in detail.

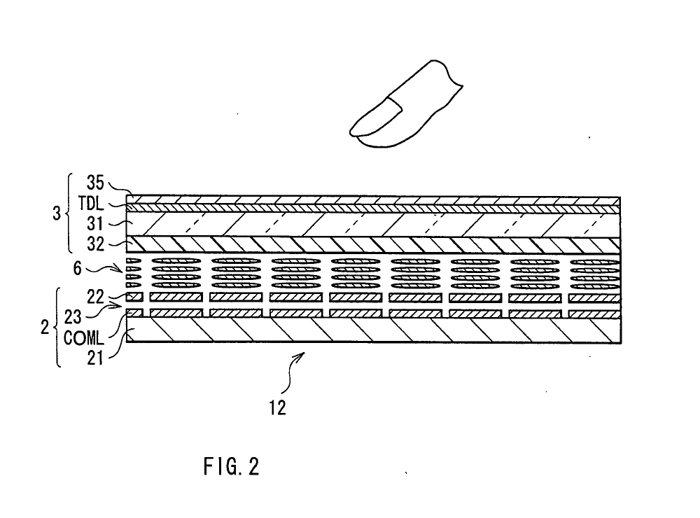

FIG. 2 illustrates an example of a sectional structure of a main part in the display section 12 with the touch detection function. This display section 12 with the touch detection function includes a pixel substrate 2, an opposite substrate 3 disposed to face this pixel substrate 2, and a liquid crystal layer 6 interposed between the pixel substrate 2 and the opposite substrate 3.

The pixel substrate 2 has a TFT board 21 serving as a circuit board, a common electrode COML, and pixel electrodes 22. The TFT board 21 functions as a circuit board where various electrodes and wiring, a thin-film transistor (TFT), and the like are formed. The TFT board 21 is made of, for example, glass. Formed on the TFT board 21 is the common electrode COML. The common electrode COML is an electrode to supply a common voltage to a plurality of pixels Pix (to be described later). This common electrode COML functions as a common drive electrode for liquid crystal display operation, and also functions as a drive electrode for touch detection operation. An insulating layer 23 is formed on the common electrode COML, and the pixel electrode 22 is formed on the insulating layer 23. The pixel electrode 22 is an electrode to supply a pixel signal for display, and is translucent. The common electrode COML and the pixel electrode 22 are each made of, for example, ITO (Indium Tin Oxide).

The opposite substrate 3 has a glass substrate 31, a color filter 32, and a touch detection electrode TDL. The color filter 32 is formed on one surface of the glass substrate 31. This color filter 32 is configured, for example, by periodically arranging color filter layers of three colors of red (R), green (G), and blue (B), and one set of the three colors of R, G; and B is associated with each display pixel. Further, the touch detection electrode TDL is formed on the other surface of the glass substrate 31. The touch detection electrode TDL is a translucent electrode and made of, for example, ITO.

On this touch detection electrode TDL, a polarizing plate 35 is disposed.

The liquid crystal layer 6 functions as a display function layer, and modulates light passing therethrough, according to the state of an electric field. This electric field is formed by a potential difference between a voltage of the common electrode COML and a voltage of the pixel electrode 22. A liquid crystal in a transverse electric field mode such as FFS (Fringe Field Switching), IPS (In Plane Switching), or the like is used for the liquid crystal layer 6.

It is to be noted that each of between the liquid crystal layer 6 and the pixel substrate 2, and between the liquid crystal layer 6 and the opposite substrate 3, an alignment film is disposed, and an incidence-side polarizing plate is disposed on the undersurface side of the pixel substrate 2, but the illustration is omitted here.

FIG. 3 illustrates a configurational example of a display pixel structure of the display section 12 with the touch detection function. The display section 12 with the touch detection function has pixels Pix arranged in the form of a matrix. Each of the pixel Pix has a TFT element Tr and a liquid crystal element LC. The TFT element Tr is configured by using a thin-film transistor and, in this example, configured by using an n-channel MOS (Metal Oxide Semiconductor) TFT. Of the TFT element Tr, a source is connected to a pixel signal line SGL, a gate is connected to a scanning signal line GCL, and a drain is connected to one end of the liquid crystal element LC. As for the liquid crystal element LC, one end is connected to a drain of the TFT element Tr, and the other end is connected to the common electrode COML.

The pixel Pix is connected to other pixels Pix belonging to the same row of the display section 12 with the touch detection function, by the scanning signal line GCL. The pixel Pix is connected to other pixels Pix belonging to the same column of the display section 12 with the touch detection function, by the pixel signal line SGL. Further, the pixel Pix is connected to other pixels Pix belonging to the same row of the display section 12 with the touch detection function, by the common electrode COML. Various signals are supplied from the display-signal processing section 11 to the scanning signal line GCL, the pixel signal line SGL, and the common electrode COML.

FIG. 4 illustrates a configurational example of a touch sensor of the display section 12 with the touch detection function, perspectively. The touch sensor is configured to include the common electrode COML provided in the pixel substrate 2 and the touch detection electrode TDL provided in the opposite substrate 3. The common electrode COML is divided into a plurality of strip-shaped electrode patterns extending in a lateral direction of this figure. When touch detection operation is performed, a driving signal Vcom is supplied sequentially to each of the electrode patterns, and sequential scanning driving is performed through time-sharing. The touch detection electrode TDL is configured to have an electrode pattern extending in a direction orthogonal to the direction in which the electrode patterns of the common electrode COML extend. The electrode patterns crossing each other by the common electrode COML and the touch detection electrodes TDL form a capacitance (a touch sensor element) at the intersection.

By this configuration, the driving signal Vcom supplied to the common electrode COML is transmitted to the touch detection electrode TDL via this capacitance, and supplied to the touch-detection-signal processing section 13 as the touch detection signal Vdet. This capacitance is changed by an external proximity object. In the display panel 10 with the touch detection function, it is possible to obtain information about the external proximity object by analyzing this touch detection signal Vdet.

Further, as illustrated in FIG. 4, the electrode patterns crossing each other form the capacitance touch sensor elements in the shape of a matrix. Therefore, it is possible to detect a position where a touch or approach of an external proximity object has occurred, by scanning the entire touch detection surface of the display section 12 with the touch detection function.

Here, the detection intensity map Dmap corresponds to a specific example of the “detection intensity mapping information” according to the embodiment of the present disclosure. The display section 12 with the touch detection function and the touch-detection-signal processing section 13 correspond to a specific example of the “touch detecting section” according to the embodiment of the present disclosure. The object-information detecting section 14 corresponds to a specific example of the “touched-position detecting section” according to the embodiment of the present disclosure.

### (Operation and Action)

Subsequently, operation and action of the information input-output device 1 of the present embodiment will be described.

First, a summary of overall operation of the information input-output device 1 will be described with reference to FIG. 1. The control section 41 of the electronic-device main unit 40 generates and supplies the display data Dd to the display panel 10 with the touch detection function. In the display panel 10 with the touch detection function, the display-signal processing section 11 generates various control signals based on the display data Dd, thereby driving the display section 12 with the touch detection function. The display section 12 with the touch detection function performs the display operation based on the various control signals supplied from the display-signal processing section 11, and outputs the touch detection signal Vdet according to an external proximity object near or touching the touch detection surface and supplies the touch detection signal Vdet to the touch-detection-signal processing section 13. Based on the touch detection signal Vdet supplied from the display section 12 with the touch detection function, the touch-detection-signal processing section 13 generates the detection intensity map Dmap in the touch detection surface and supplies the generated map Dmap to the object-information detecting section 14. The object-information detecting section 14 determines the object information Dobj such as the touched position of the external proximity object, based on the detection intensity map Dmap supplied from the touch-detection-signal processing section 13.

When determining the object information Dobj based on the detection intensity map Dmap, the object-information detecting section 14 first determines a touched position roughly, and then determines a touched position again with higher accuracy by narrowing a region. This operation will be described below in detail.

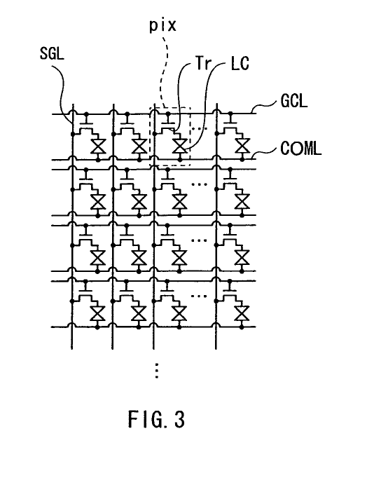

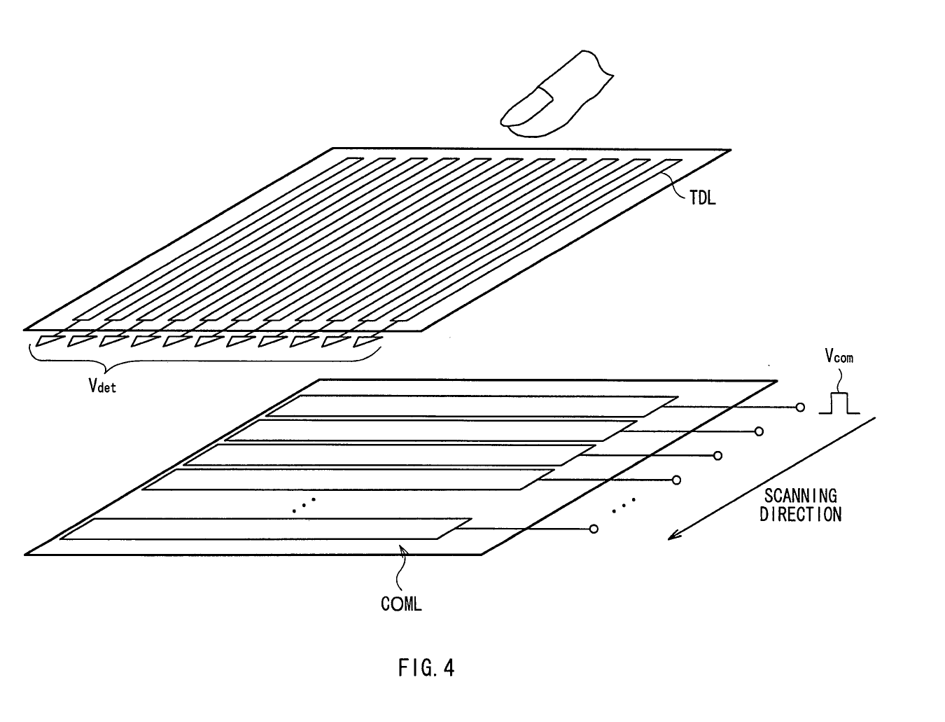

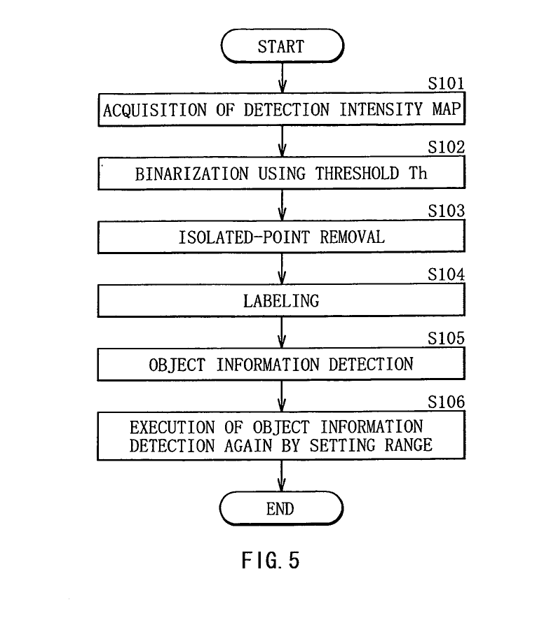

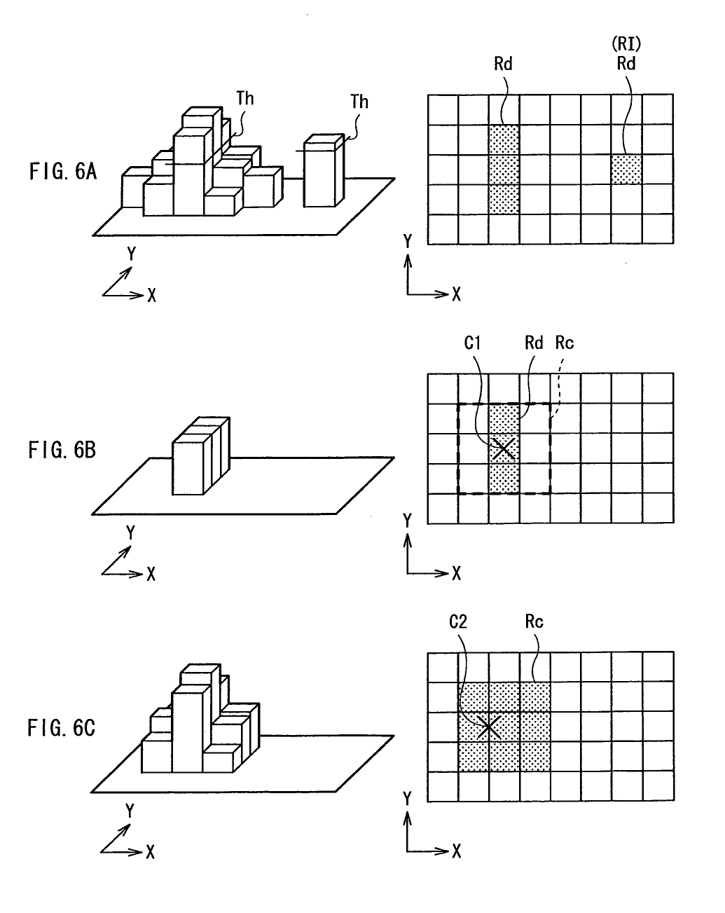

FIG. 5 is a flowchart of the operation in the object-information detecting section 14. FIGS. 6A to 6C are schematic diagrams for explaining the operation of the object-information detecting section 14, and illustrate the operation of a certain region within the touch detection surface.

First, the object-information detecting section 14 acquires the detection intensity map Dmap from the touch-detection-signal processing section 13 (step S101). The detection intensity map Dmap indicates detection intensity P in each of the touch sensor elements (detecting element) on the touch detection surface, in a map. In this example, a part where there is no external proximity object is “0”, and the closer to the touch detection surface the external proximity object is, the larger positive value the map indicates.

Next, the object-information detecting section 14 performs binarization of the detection intensity P, by using a threshold Th (step S102). Specifically, at first, the object-information detecting section 14 compares each detection intensity P of the detection intensity map Dmap with the threshold Th (in the left diagram of FIG. 6A). Subsequently, a binarization map Dmap2 is created by regarding each detection intensity P as “1” (a region Rd in the right diagram of FIG. 6A) when the detection intensity P is higher than the threshold, and regarding each detection intensity P as “0” when the detection intensity P is smaller than the threshold.

Next, the object-information detecting section 14 performs isolated-point removal (noise removal) (step S103). As a method of removing an isolated point, for example, a method described in Japanese Unexamined Patent Application Publication No. 2007-102730 may be used. In this method, a noise is removed by filtering the binarization map Dmap2 and thereby a region where the number of detecting elements indicating “1” in the region Rd is small is regarded as an isolated point, and setting all the values in the region Rd to “0”. In this example, the region Rd (an isolated region RI) illustrated in the right diagram of FIG. 6A meets this condition and thus is removed by this isolated point removal as illustrated in FIG. 6B.

Subsequently, the object-information detecting section 14 performs labeling (step S104). Specifically, for example, the object-information detecting section 14 makes a classification for each region Rd in the binarization map Dmap2. At this time, the object-information detecting section 14 also determines the number of regions Rd in the binarization map Dmap2. For example, when two fingers touch the touch detection surface, there are two regions Rd in total at positions corresponding to the touched positions and thus, the number of regions Rd is two.

Next, the object-information detecting section 14 performs object information detection (step S105). Specifically, the object-information detecting section 14 determines coordinates (Xc1, Yc1) of a centroid C1 of the region Rd (the right diagram of FIG. 6B), for each region Rd labeled in step S104, in the binarization map Dmap2. In this example, computing of this centroid C1 is performed to determine the centroid of the region Rd by using the value merely binarized, but is not limited to this. Instead, for example, the centroid may be determined by performing weighting using the detection intensity P in each detecting element of the region Rd (weighted centroid computing to be described later). It is to be noted that the object-information detecting section 14 may further determine the range or size of the region Rd in the binarization map Dmap2, in the object information detection in the step S105.

Subsequently, the object-information detecting section 14 sets a range and performs the object information detection again (step S106). Specifically, the object-information detecting section 14 sets a region Rc to perform the object information detection again with higher accuracy, based on the coordinates of the centroid C1 determined in step S105, in each region Rd (FIG. 6B). In this example, the detecting element having the centroid C1 and adjacent detecting elements are set as the region Rc. Subsequently, the object-information detecting section 14 determines barycentric coordinates by performing the weighted centroid computing through use of the detection intensity P in each detecting element of this region Rc, and regards the determined barycentric coordinates as a touched position. The weighted centroid computing is to determine coordinates (xc2, yc2) of a centroid C2 by performing weighting using the detection intensity P in each detecting element of the region Rc. For example, the weighted centroid computing may use the following expressions.

$$\begin{matrix}Xc 2 = \frac{{\sum }_{y} {\sum }_{x} Pxy \cdot X}{{\sum }_{y} {\sum }_{x} Pxy} & ( 1 ) \\ Yc 2 = \frac{{\sum }_{y} {\sum }_{x} Pxy \cdot Y}{{\sum }_{y} {\sum }_{x} Pxy} & ( 2 )\end{matrix}$$

Here, Pxy indicates the detection intensity P at the coordinates (x, y). Further, addition by Σ is performed for those within the region Rc. This computing is carried out for every region Rc. In other words, the object-information detecting section 14 may determine each of the touched positions with high accuracy, when there are a plurality of touches on the touch detection surface. It is to be noted that the object-information detecting section 14 may determine the range or size of a touch, in the object information detection in the step S106.

In this example, the detecting element having the centroid C1 and the adjacent detecting elements are set as the region Rc. However, the region Rc is not limited to this and, for example, may further include outside detecting elements. Alternatively, in FIG. 4, for example, when a touch-sensor-element density in a certain direction is low, such as when the density of the number of touch detection electrodes TDL is less than the density of the number of common drive electrodes COML, the region Rc may be set to be broader in that direction. This makes it possible to improve accuracy in performing the centroid computing, because data in the x-axis direction included in the region Rc becomes large. Further, when the range and size of the region Rd are determined in step S105, the region Rc may be set using these in addition to the coordinates of the centroid C1.

This completes the flow of the object-information detecting section 14.

Here, the threshold Th is equivalent to a specific example of the “predetermined threshold” according to the embodiment of the present disclosure. The region Rd before the isolated region RI is removed is equivalent to a specific example of the “touch region” according to the embodiment of the present disclosure, and the region Rd after the isolated region RI is removed is equivalent to a specific example of the “effective region” according to the embodiment of the present disclosure. The region Rc is equivalent to a specific example of the “computation region” according to the embodiment of the present disclosure.

In this way, in the information input-output device 1, when the object information Dobj is determined based on the detection intensity map Dmap, the coordinates of the centroid C1 are first determined by comparing the detection intensity P with the predetermined threshold Th, and the coordinates of the centroid C2 are determined based on the determined coordinates of the centroid C1, by performing a reduction to the region Rc including the neighborhood of these coordinates. Therefore, it is possible to increase the accuracy of the touched position detection efficiently.

### (Effects)

As described above, in the present embodiment, barycentric coordinates are determined by comparing the detection intensity with the predetermined threshold, barycentric coordinates are determined again in the region Rc set based on the determined barycentric coordinates, and the barycentric coordinates determined again are regarded as the touched position. Therefore, it is possible to increase the accuracy of the touched position detection efficiently.

Further, in the present embodiment, as described above, the object information detection is carried out for each of the a plurality of regions Rd and thus, it is possible to detect more than one touch at the same time.

Furthermore, in the present embodiment, the weighted centroid computing is performed when the second barycentric coordinates are determined and thus, it is possible to enhance the accuracy of the touched position detection.

### 2. Second Embodiment

Next, there will be described an information input-output device 7 according to the second embodiment of the present disclosure. In the present embodiment, when object information Dobj is determined based on a detection intensity map Dmap, a rough touched position is first determined using a high threshold and then, a detailed touched position is determined using a low threshold. In other words, in the present embodiment, the information input-output device 7 is configured using an object-information detecting section 15 that performs such operation. Otherwise, the information input-output device 7 is configured in a manner similar to the first embodiment (FIG. 1) described above. It is to be noted that the substantially same elements as those of the information input-output device 1 in the first embodiment will be provided with the same reference characters as those in the first embodiment, and the description will be omitted as appropriate.

The information input-output device 7 includes a display panel 70 with a touch detection function. The display panel 70 with the touch detection function has the object-information detecting section 15. When determining the object information Dobj based on the detection intensity map Dmap, the object-information detecting section 15 first determines a rough touched position using a high threshold ThH, and then determines a detailed touched position using a low threshold ThL. This operation will be described below in detail.

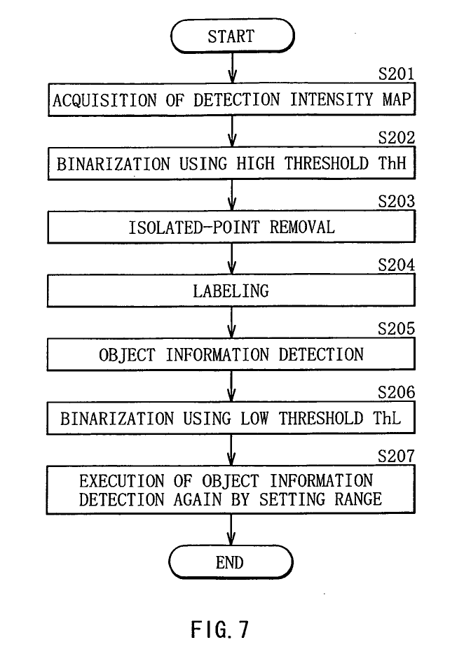

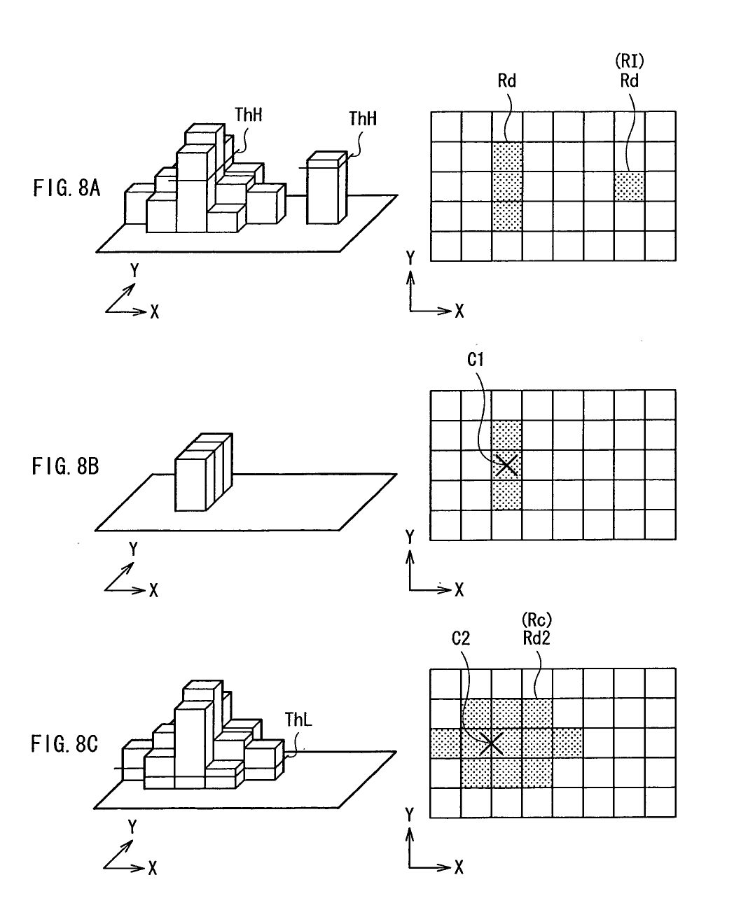

FIG. 7 illustrates a flowchart of the operation in the object-information detecting section 15. FIGS. 8A to 8C are schematic diagrams for explaining the operation of the object-information detecting section 15, and illustrate the operation of a certain region within the touch detection surface.

First, the object-information detecting section 15 acquires the detection intensity map Dmap from a touch-detection-signal processing section 13 (step S201). Subsequently, the object-information detecting section 15 performs binarization of a detection intensity P, by using the high threshold ThH (step S202), and performs isolated-point removal (noise removal) (step S203). Further, the object-information detecting section 15 performs labeling (step S204) and object information detection (step S205). The operation in each of these steps S201 to S205 is similar to the operation in each of steps S101 to S105 in the first embodiment described above.

Subsequently, the object-information detecting section 15 performs binarization of the detection intensity P, by using the low threshold ThL (step S206). Specifically, at first, the object-information detecting section 15 compares each detection intensity P of the detection intensity map Dmap with the low threshold ThL (the left figure of FIG. 8C). The object-information detecting section 15 sets “1” when each detection intensity P is higher than the low threshold ThL (a region Rd2 in the right figure of FIG. 8C), and sets “0” when each detection intensity P is smaller than the low threshold ThL, thereby creating a binarized map Dmap3. At this time, the object-information detecting section 15 performs this operation only on the neighborhood of each region Rd labeled in step S204. Specifically, for example, the object-information detecting section 15 creates the binarized map Dmap3 by setting, among regions where the result of binarizing the detection intensity P of the entire touch detection surface is “1”, a region including a region Rd in the binarization map Dmap2 as a region Rd2, and a region excluding the region Rd as “0”. As a result, the region Rd2 in the binarized map Dmap3 includes the region Rd in the binarization map Dmap2. Therefore, when, for example, there is a region where the detection intensity P is higher than the low threshold ThL and lower than the high threshold ThH, this region is “0” when the comparison with the high threshold ThH is made in step S202 and is not labeled and thus will not become “1” in the binarized map Dmap3 generated in step S206 even though the detection intensity P is higher than the low threshold ThL.

Subsequently, the object-information detecting section 15 sets a range and performs the object information detection again (step S207). Specifically, the object-information detecting section 15 sets this region Rd2 in a region Rc (the right figure of FIG. 8C), and using the detection intensity P in each detecting element of this region Rc, determines barycentric coordinates by operating weighted centroid computing in a manner similar to the first embodiment, and regards the barycentric coordinates as a touched position. It is to be noted that the object-information detecting section 15 may further determine the range or size of a touch in the object information detection in this step S207.

This completes the flow of the object-information detecting section 15.

Here, the high threshold ThH is equivalent to a specific example of the “predetermined threshold” in the embodiment of the present disclosure, and the low threshold ThL is equivalent to a specific example of the “other threshold” in the embodiment of the present disclosure.

In this way, in the information input-output device 7, when the object information Dobj is determined based on the detection intensity map Dmap, the labeling is first performed by comparing the detection intensity P with the predetermined high threshold ThH, and then the detection intensity P is compared with the predetermined low threshold ThL in the region where the labeling is performed, and thereby coordinates of a centroid C2 in the region Rd2 obtained as a result of the latter comparison are determined. Therefore, it is possible to increase the accuracy of the touched position detection efficiently.

### (Effects)

As described above, in the present embodiment, the labeling is performed by comparing the detection intensity with the high threshold, the detection intensity on the neighborhood of the region where the labeling is performed is compared with the low threshold, the barycentric coordinates are determined based on the region thus obtained as a result of the latter comparison, and the barycentric coordinates are regarded as the touched position. Therefore, it is possible to increase the accuracy of the touched position detection efficiently. Other effects are similar to those in the first embodiment.

### 3. Application Examples

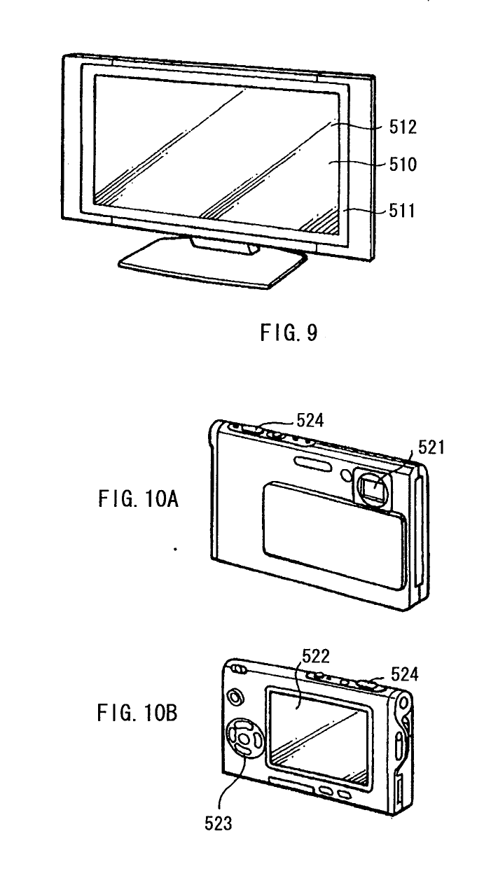

Next, with reference to FIG. 9 to FIG. 13G, there will be described application examples of the touch detector in each of the embodiments described above. The touch detector in each of the embodiments and the like described above may be applied to electronic devices in all fields, such as television receivers, digital cameras, laptop computers, portable terminal devices such as portable telephones, and video cameras. In other words, it is possible to apply the touch detector in each of the embodiments and the like described above to electronic devices in all fields, which display externally-input video signals or internally-generated video signals as image or video.

### APPLICATION EXAMPLE 1

FIG. 9 illustrates an external view of a television receiver to which the touch detector in any of the embodiments and the like described above is applied. This television receiver has, for example, a video display screen section 510 that includes a front panel 511 and a filter glass 512, and this video display screen section 510 is configured using the touch detector according to any of the embodiments and the like described above.

### APPLICATION EXAMPLE 2

FIGS. 10A and 10B each illustrate an external view of a digital camera to which the touch detector in any of the embodiments and the like described above is applied. This digital camera includes, for example, a flash emitting section 521, a display section 522, a menu switch 523, and a shutter release button 524, and the display section 522 is configured using the touch detector according to any of the embodiments and the like described above.

### APPLICATION EXAMPLE 3

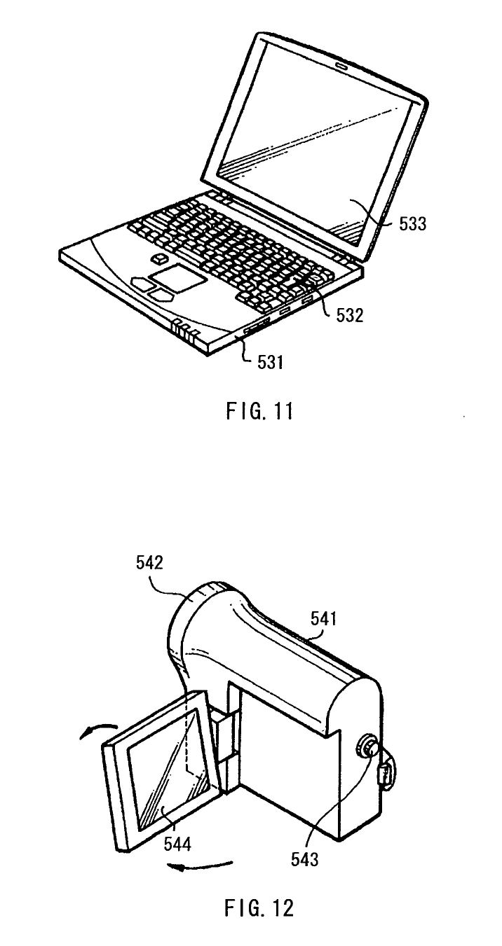

FIG. 11 illustrates an external view of a laptop computer to which the touch detector in any of the embodiments and the like described above is applied. This laptop computer includes, for example, a main section 531, a keyboard 532 for entering characters and the like, and a display section 533 that displays an image, and the display section 533 is configured using the touch detector according to any of the embodiments and the like described above.

### APPLICATION EXAMPLE 4

FIG. 12 illustrates an external view of a video camera to which the touch detector in any of the embodiments and the like described above is applied. This video camera includes, for example, a main section 541, a lens 542 disposed on a front face of this main section 541 to shoot an image of a subject, a start/stop switch 543 used at the time of shooting, and a display section 544, and the display section 544 is configured using the touch detector according to any of the embodiments and the like described above.

### APPLICATION EXAMPLE 5

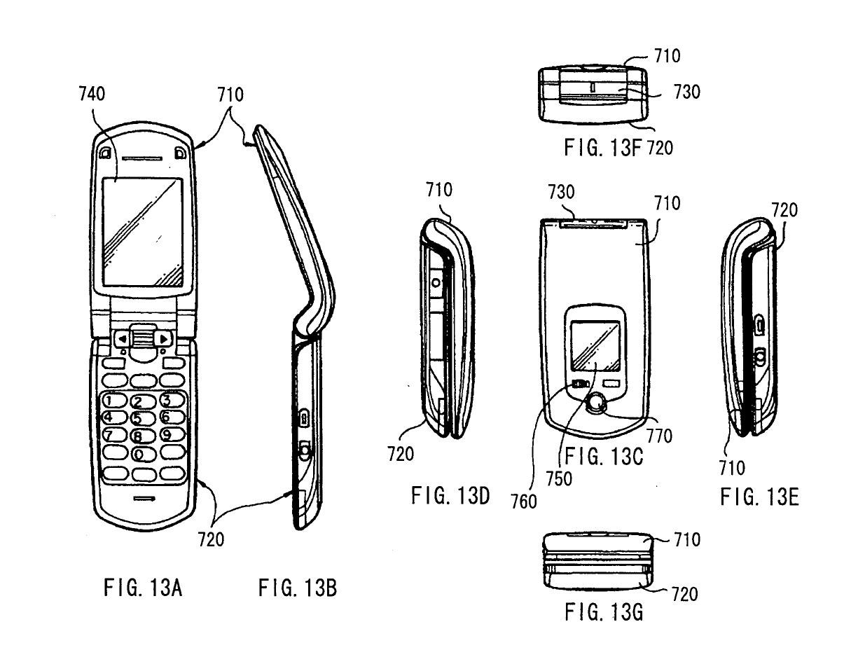

FIGS. 13A to 13G illustrate external views of a portable telephone to which the touch detector in any of the embodiments and the like described above is applied. This portable telephone is, for example, a device in which an upper housing 710 and a lower housing 720 are connected by a coupling section (hinge section) 730, and includes a display 740, a sub-display 750, a picture light 760, and a camera 770. The display 740 or the sub-display 750 is configured using the touch detector according to any of the embodiments and the like described above.

The present technology has been described by using some embodiments, and application examples of electronic devices, but is not limited to these embodiments and like, and may be variously modified.

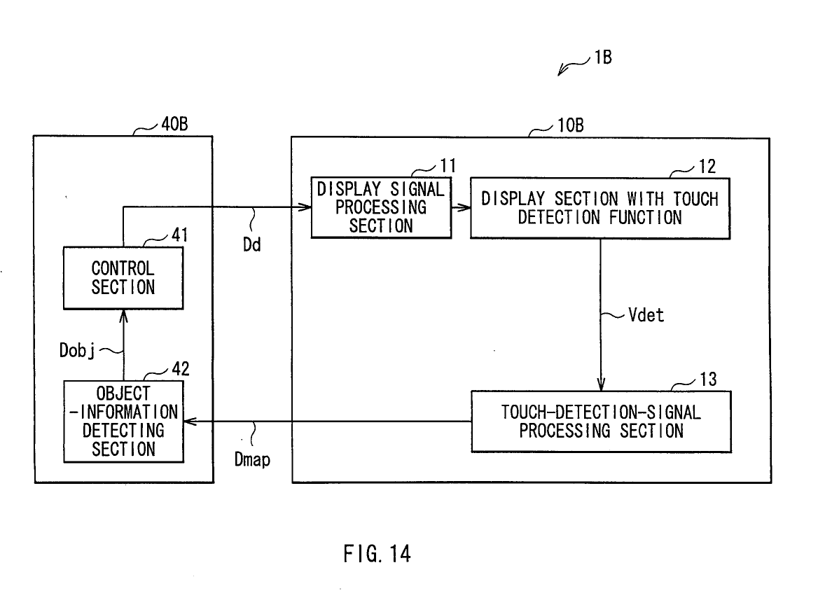

For example, in each of the embodiments described above, the display panel with the touch detection function has the object-information detecting section, but the present technology is not limited to this example. Instead, an electronic-device main unit may have an object-information detecting section as illustrated in FIG. 14.

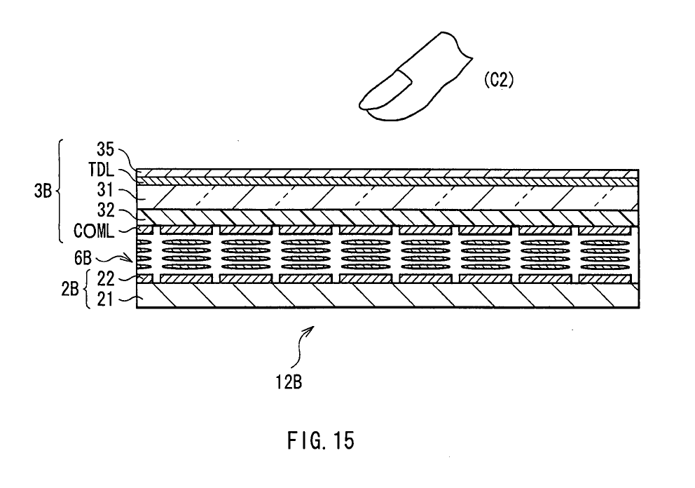

For example, in each of the embodiments described above, the liquid crystal display using the liquid crystal in the transverse electric field mode such as FFS, IPS, or the like and the touch detection device are integrated. However, instead, a liquid crystal display using a liquid crystal in any of various modes such as TN (Twisted Nematic), VA (Vertical Alignment), ECB (Electrically Controlled Birefringence) and touch detection devices may be integrated. When such a liquid crystal is used, the display unit with the touch detection function may be configured as illustrated in FIG. 15. FIG. 15 illustrates an example of a sectional structure of a main part in the display unit with the touch detection function according to the present modification, and depicts a state in which a liquid crystal layer 6B is interposed between a pixel substrate 2B and an opposite substrate 3B. The name, function etc. of each of other parts are similar to those in the case of FIG. 5 and thus, the description will be omitted. In this example, a common electrode COML used for both display and touch detection is formed in the opposite substrate 3B, unlike the case in FIG. 2.

Further, for example, in each of the embodiments described above, a so-called in-cell type in which the liquid crystal display and the capacitance touch detection device are integrated is employed, but the present technology is not limited to this example. Instead, for example, a type in which a capacitance touch detection device is attached to a liquid crystal display may be employed.

Furthermore, for example, in each of the embodiments described above, the touch detection device is of capacitance type, but is not limited to this type, and may be of an optical type, or a resistive film type.

Moreover, for example, in each of the embodiments described above, the liquid crystal element is used as the display element, but the present technology is not limited to this example, and, for example, an EL (Electro Luminescence) element may be employed.

The present disclosure contains subject matter related to that disclosed in Japanese Priority Patent Application JP 2010-215532 filed in the Japan Patent Office on Sep. 27, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A touch detector comprising:
a touch detecting section generating detection intensity mapping information including detection intensity values according to an external proximity object; and
a touched-position detecting section determining a touched position based on one or a plurality of touch regions determined by comparing each of the detection intensity values with a predetermined threshold,
wherein the touched-position detecting section selects an effective region from the one or each of the plurality of touch regions, establishes a computation region for the effective region, and determines a centroid as the touched position with use of the detection intensity values in the computation region.

2. The touch detector according to claim 1, wherein the computation region is established to include a center of the selected effective region.

3. The touch detector according to claim 2, wherein the touch detecting section includes a plurality of touch detecting elements arranged side by side, an arrangement density of the touch detecting elements in one direction differing from that in another direction, and
the computation region is established to be broader in a direction where the arrangement density of the touch detecting elements is low.

4. The touch detector according to claim 1, wherein the computation region is established for a region which includes the effective region and is determined by comparing each of the detection intensity values in the detection intensity mapping information with another threshold lower than the predetermined threshold.

5. The touch detector according to claim 1, wherein
the touch detecting section detects a noise region from the one or plurality of touch regions, the noise region resulting from noises, and
the touch detecting section selects a region other than the noise region as the effective region.

6. The touch detector according to claim 1, wherein the touch detecting section generates the detection intensity mapping information, based on a variation in capacitance due to the external proximity object.

7. A touch detector comprising:
a touch detecting section; and
a touched-position detecting section obtaining detection intensity values from the touch detecting section,
wherein the touched-position detecting section establishes a computation region for an effective region determined by comparing the detection intensity values with a predetermined threshold, and determines a centroid with use of the detection intensity values in the computation region.

8. The touch detector according to claim 7, wherein the computation region is established to include a center of the effective region.

9. The touch detector according to claim 8, wherein the touch detecting section includes a plurality of touch detecting elements arranged side by side, an arrangement density of the touch detecting elements in one direction differing from that in another direction, and
the computation region is established to be broader in a direction where the arrangement density of the touch detecting elements is low.

10. The touch detector according to claim 7, wherein the computation region is established for a region which includes the effective region and is determined by comparing with another threshold lower than the predetermined threshold.

11. A display unit with a touch detection function, the display unit comprising:
a plurality of display elements;
a touch detecting section generating detection intensity mapping information including detection intensity values according to an external proximity object; and
a touched-position detecting section determining a touched position based on one or a plurality of touch regions determined by comparing each of the detection intensity values with a predetermined threshold,
wherein the touched-position detecting section selects an effective region from the one or each of the plurality of touch regions, establishes a computation region for the effective region, and determines a centroid as the touched position with use of the detection intensity values in the computation region.

12. A touched-position detecting method comprising:
determining one or a plurality of touch regions by comparing, based on detection intensity mapping information including detection intensity value according to an external proximity object, the detection intensity value with a predetermined threshold;
selecting an effective region from the one or each of the plurality of touch regions;
establishing a computation region for the effective region; and
determining a centroid as the touched position with use of the detection intensity values in the computation region.

13. An electronic device comprising:
a touch detector; and
a control section performing operation control using the touch detector,
wherein the touch detector includes
a touch detecting section generating detection intensity mapping information including detection intensity values according to an external proximity object; and
a touched-position detecting section determining a touched position based on one or a plurality of touch regions determined by comparing each of the detection intensity values with a predetermined threshold, and
the touched-position detecting section selects an effective region from the one or each of the plurality of touch regions, establishes a computation region for the. effective region, and determines a centroid as the touched position with use of the detection intensity values in the computation region.
